(19) United States
(12) Patent Application Publication
(10) Pub. No.: US 2026/0326735 A1
(43) Pub. Date: Oct. 22, 2026

(54) Electromechanical Brake

(71) Applicant: BETHEL AUTOMOTIVE SAFETY SYSTEMS CO., LTD., Wuhu (CN)

(72) Inventors: Yundong LI, Wuhu (CN); Jiutao ZOU, Wuhu (CN); Shangyang LI, Wuhu (CN); Leilei LI, Wuhu (CN); Yuancheng ZHU, Wuhu (CN); Fengliang GUO, Wuhu (CN); Ming XUAN, Wuhu (CN); Wenyan DING, Wuhu (CN)

(73) Assignee: BETHEL AUTOMOTIVE SAFETY SYSTEMS CO., LTD., Wuhu (CN)

(21) Appl. No.: 19/728,354

(22) Filed: Jul. 2, 2026

Related U.S. Application Data
(63) Continuation-in-part of application No. 19/068,025, filed on Mar. 3, 2025.
Application No. 19/068,025 is a continuation of application No. PCT/CN2023/115280, filed on Aug. 28, 2023.

(30) Foreign Application Priority Data
Sep. 5, 2022 (CN) 2022110797912
Jul. 2, 2025 (CN) 202510910689X
Jul. 2, 2025 (CN) 202521385430X

(51) Int. Cl. B60T 13/74; F16D 55/00; F16D 55/227; F16D 65/00; F16D 65/18; F16D 121/24; F16D 125/40

(52) U.S. Cl. CPC B60T 13/746; F16D 55/227; F16D 65/0056; F16D 65/0068; F16D 65/0087; F16D 65/18; F16D 2055/0008; F16D 2055/0016; F16D 2121/24; F16D 2125/40

(57) ABSTRACT

An electromechanical brake comprising a mounting bracket, a caliper body, a brushless motor, and a transmission device is provided. An outer brake pad is slidably mounted on the front jaw, and an inner brake pad is slidably mounted on the rear jaw, with a brake disc positioned between the front and rear jaws. The caliper body is slidably connected to the mounting bracket via guide rods. The caliper body has a piston cylinder, inside which is a piston connected to the transmission device and capable of axial sliding. The front end of the caliper body has a hook portion, and the rear end of the caliper body has two caliper lugs, each guide rod being connected between one caliper lug and the rear jaw. The brushless motor is mounted on the transmission-device housing, which is fixed to the rear end of the caliper body with at least three screws.

### CROSS REFERENCE TO RELATED APPLICATIONS

The present disclosure is a continuation-in-part application claiming the benefit of priority to a U.S. patent application Ser. No. 19/068,025, filed on Mar. 3, 2025 and entitled “BRAKE CALIPER”, which is a continuation of a PCT International Application No. PCT/CN2023/115280 filed on Aug. 28, 2023, which claims the benefit of priority of a Chinese Patent Application No. CN 202211079791.2 filed with CNIPA on Sep. 5, 2022, the disclosure of the above applications are incorporated herein by reference in their entirety for all purposes.

The present disclosure further claims the benefit of priority to Chinese patent applications filed on 2 Jul. 2025 under Application No. CN 202510910689.X, titled “ELECTROMECHANICAL BRAKE”, and Application No. CN 202521385430.X, titled “ELECTROMECHANICAL BRAKE”, the disclosure of the above applications are incorporated herein by reference in their entirety for all purposes.

### FIELD OF THE INVENTION

The present disclosure relates to vehicle braking technology and, more particularly, to an electromechanical brake.

### BACKGROUND OF THE INVENTION

The reliability of a vehicle's braking system is fundamental to driving safety. In recent years, as electronic control technologies have continued to advance, electromechanical brakes (EMBs) have been increasingly adopted in modern vehicles. An EMB generally includes a mounting bracket, a caliper body, an electronic control unit, a motor, a transmission device, a motion-conversion mechanism, a piston, and brake pads. During operation, torque generated by the motor is first reduced and amplified by the transmission device and is then converted from rotational motion to linear motion by the motion-conversion mechanism. This linear motion drives the piston forward, and the piston in turn presses the brake pads against the brake disc to generate braking force. Typically, the motion-conversion mechanism and the piston are disposed on the caliper body, while the brake pads are mounted on the mounting bracket. The electronic control unit and the motor are usually installed directly on the housing of the transmission device, and the mounting bracket is fixed to the vehicle body.

However, existing designs present several drawbacks. For example, the guide rods that enable relative sliding between the caliper body and the mounting bracket often extend through the entire mounting bracket along the movement direction of the brake pads. As a result, these guide rods may interfere with the brake disc positioned adjacent to the brake pads.

Moreover, conventional structures typically extend the housing of the transmission device to form a cantilever section for mounting the motor. Under vibration conditions, this cantilever section exhibits a relatively large vibration amplitude. Because the motor mounted on the cantilever section is heavy and its center of gravity is offset from the housing's fixed point, the vibration of the housing is further amplified. Consequently, the motor or the electronic control unit mounted on the housing is prone to damage, which may lead to failure of the electromechanical brake and pose a serious threat to driving safety.

For instance, Chinese patent application CN117948361A discloses an electromechanical brake in which the housing of the transmission device is generally V-shaped, and the brake motors are mounted on two arms of the V-shaped housing. Two flanges are provided at the central portion of the housing, and a pair of bolts connects these flanges to the housing of the brake actuator (i.e., the caliper body). The two arms of the V-shaped housing also function as cantilever sections. Therefore, mounting the brake motors on these cantilever sections increases the vibration of the housing of the transmission-device, thereby adversely affecting the reliability of the electromechanical brake.

### SUMMARY OF THE INVENTION

The present disclosure provides an electromechanical brake, which effectively prevents interference between the brake disc mounted between the front and rear brake caliper jaws and the guide rods.

The electromechanical brake includes a mounting bracket, a caliper body, a brushless motor, and a transmission device. The caliper body is slidably connected to the mounting bracket via two guide rods, an inner brake pad and an outer brake pad are slidably mounted on the mounting bracket, and a brake disc is positioned between the inner brake pad and the outer brake pad. The caliper body is provided with a piston cylinder, and the piston cylinder houses a piston. The piston is connected to an output end of the transmission device and is capable of axial sliding. Forward movement of the piston pushes the inner brake pad against the brake disc. A front end of the caliper body is provided with a hook portion located on an outer side of the outer brake pad. The transmission device includes a housing, the brushless motor is mounted on the housing, and the housing is fixedly connected to a rear end of the caliper body via a fastener.

Furthermore, the fastener includes at least three screws, at least two of which are disposed on two sides of the brushless motor, and at least two of which are disposed on two sides of the piston cylinder.

Furthermore, the transmission device is a gear reduction mechanism, an output end of the brushless motor is connected to an input end of the transmission device, the output end of the transmission device is an output shaft, and the output shaft extends into the piston cylinder and is connected to the piston via a motion-conversion mechanism.

Furthermore, the brushless motor and the piston cylinder are located between the two guide rods, and an axis of the brushless motor, an axis of the piston cylinder, and an axis of each of the two guide rods are all parallel to each other.

Furthermore, the two guide rods include a first guide rod and a second guide rod, the first guide rod is positioned adjacent to the brushless motor, and the second guide rod is positioned adjacent to the piston cylinder. In a plane perpendicular to each of the axis of the piston cylinder, the axis of the brushless motor, and an axis of the first guide rod, projections of the axis of the piston cylinder, the axis of the brushless motor, and the axis of the first guide rod onto the plane are denoted as points P, M, and G, respectively, and the angle ∠PMG is greater than or equal to 70° and less than or equal to 180°.

Furthermore, the mounting bracket includes a front jaw and a rear jaw. The outer brake pad is slidably mounted on the front jaw, and the inner brake pad is slidably mounted on the rear jaw.

Furthermore, a rear end of the caliper body is provided with two caliper lugs, and the two caliper lugs are integrally formed with the piston cylinder and extend radially outward from two sides of an outer wall of the piston cylinder. The first guide rod is connected between one of the two caliper lugs and the rear jaw, and the second guide rod is connected between remaining one of the two caliper lugs and the rear jaw.

Furthermore, a first end of each of the first guide rod and the second guide rod is fixed to the rear jaw, and a second end of each of the first guide rod and the second guide rod is in sliding engagement with a corresponding one of guide sleeves mounted on the caliper lugs.

Furthermore, a first end of one of the first guide rod and the second guide rod is fixed to the rear jaw, and a second end of the one of the first guide rod and the second guide rod is in sliding engagement with a guide sleeve mounted on one of the caliper lugs. A first end of remaining one of the first guide rod and the second guide rod is fixed to remaining one of the caliper lugs, and a second end of the remaining one of the first guide rod and the second guide rod is in sliding engagement with a guide sleeve mounted on the rear jaw.

Furthermore, a slot for accommodating the brake disc is formed between the front jaw and the rear jaw, and the rear jaw is provided with one or more mounting holes configured for vehicle-body mounting.

Furthermore, a front surface of the housing is connected to the rear end of the caliper body, and the brushless motor is mounted on the front surface of the housing.

Furthermore, the caliper body is provided with a clearance space to prevent interference with the brushless motor.

Furthermore, the clearance space is a through-hole and is provided in one of the caliper lugs.

Compared with the existing technology, the beneficial effects of the present disclosure are:

In the present disclosure, the mounting bracket includes a front jaw and a rear jaw, with the space between the front jaw and the rear jaw used to accommodate the vehicle's brake disc; the caliper body is slidably connected to the mounting bracket via two guide rods; the rear end of the caliper body is provided with two caliper lugs, which are integrally formed with the piston cylinder and extend radially outward from two sides of the outer wall of the piston cylinder; and each of the two guide rods is connected between a corresponding one of the caliper lugs and the rear jaw of the mounting bracket. This makes it easier to prevent the guide rods from interfering with the brake disc mounted between the front and rear brake caliper jaws.

The electromechanical brake of the present disclosure includes a mounting bracket, a caliper body, a brushless motor, and a transmission device. The transmission device includes a housing; the brushless motor is mounted on the housing of the transmission device; and the housing is fixedly connected to the rear end of the caliper body via at least three screws, with at least two of these screws located on two sides of the brushless motor and at least two of these screws located on two sides of the piston cylinder. This ensures that the housing is tightly connected to the rear end of the caliper body, guarantees the flatness of the connection between the housing and the rear end of the caliper body, and enhances the caliper body's support for the brushless motor mounting portion of the housing, thereby effectively reducing vibration of the brushless motor mounting portion of the housing, which in turn effectively reduces vibration in the housing, thereby minimizing the risk of damage to the brushless motor or electronic control unit mounted on the housing and improving the reliability of the electromechanical brake to ensure driving safety.

In the present disclosure, the brushless motor and the piston cylinder are located between the two guide rods, and an axis of the brushless motor, an axis of the piston cylinder, and an axis of each of the two guide rods are all parallel to each other. The two guide rods include a first guide rod and a second guide rod, the first guide rod is positioned adjacent to the brushless motor, and the second guide rod is positioned adjacent to the piston cylinder. In a plane perpendicular to each of the axis of the piston cylinder, the axis of the brushless motor, and an axis of the first guide rod, projections of the axis of the piston cylinder, the axis of the brushless motor, and the axis of the first guide rod onto the plane are denoted as points P, M, and G, respectively, and the angle ∠PMG is greater than or equal to 70°. The caliper body is slidably connected to the mounting bracket via two guide rods, Thus, by positioning the first guide rod close to the brushless motor and setting ∠PMG to a value greater than or equal to 70°, the support provided by the first guide rod for the portion of the caliper body corresponding to the brushless motor is enhanced. This improves the cantilever condition of that portion of the caliper body, thereby providing more stable support for the housing as well.

In the present disclosure, the front surface of the housing is connected to the rear end of the caliper body, and the brushless motor is mounted on the front surface of the housing. This avoids layout challenges caused by limited space when installing a brushless motor on the rear surface of the housing, while also effectively reducing the overall structural dimensions of the electromechanical brake.

### BRIEF DESCRIPTION OF DRAWINGS

FIG. 1 is a schematic diagram of an electromechanical brake according to the present disclosure, viewed from one angle.

FIG. 2 is a schematic diagram of the electromechanical brake according to the present disclosure, viewed from another angle.

FIG. 3 is an exploded view of the electromechanical brake according to the present disclosure.

FIG. 4 is a schematic diagram of a caliper body according to the present disclosure, viewed from one angle.

FIG. 5 is a schematic diagram of the caliper body according to the present disclosure, viewed from another angle.

FIG. 6 is a top view of a mounting bracket in the electromechanical brake according to the present disclosure.

FIG. 7 is a side view of the mounting bracket in the electromechanical brake according to the present disclosure.

FIG. 8 is a schematic diagram of a brake disc disposed between inner and outer brake pads, both mounted on the mounting bracket.

FIG. 9 is a front view of the electromechanical brake according to the present disclosure.

FIG. 10 is a schematic diagram showing a cross-sectional structure at A-A in FIG. 9.

FIG. 11 is a schematic diagram showing another cross-sectional structure at A-A in FIG. 9.

### REFERENCE NUMERALS

1—Mounting bracket; 101—Front jaw; 102—Rear jaw; 103—Slot; 104—Mounting hole; 2—Caliper body; 201—Piston cylinder; 202—Hook portion; 203—Caliper lug; 204—Clearance space; 205—Guide sleeve; 3—Brushless motor; 4—Transmission device; 401—Housing; 5a—First guide rod; 5b—Second guide rod; 6a—Outer brake pad; 6b—Inner brake pad; 7a—First screw; 7b—Second screw; 7c—Third screw; 7d—Fourth screw; 8—Piston; 9—Brake disc.

### DETAILED DESCRIPTION

In the following, embodiments of the present disclosure will be described in further detail with reference to the accompanying drawings. The embodiments are exemplary and are not to be construed as restricting the present disclosure.

It should be noted that terms such as “center”, “longitudinal”, “horizontal”, “up”, “down”, “front”, “rear”, “left”, “right”, “vertical”, “horizontal”, “top”, “bottom”, “inside”, and “outside” indicate the orientation or position relationship based on those shown in the accompanying drawings. It is only for the convenience of describing and simplifying the description, and does not indicate or imply that the device or component mentioned must have a specific orientation, be constructed and operated in a specific orientation, and cannot be construed as restricting the present disclosure. In addition, the terms like “first” and “second” are used for indication purpose only, and are not to be construed as indicating or implying relative importance.

In the present disclosure, unless otherwise expressly specified, terms such as “installation”, “connection”, and “coupling” should be broadly understood. For example, when one element is referred to as being “connected to” another element, one element may be fixedly connected to, detachably connected to, or integrally connected to another element, may be mechanically connected to or electrically connected to another element, may be directly connected to another element, or may be indirectly connected to another element with another element interposed therebetween. These two elements may also communicate with each other internally. For those skilled in the art, the specific meanings of the above terms in the present disclosure can be understood based on specific situations.

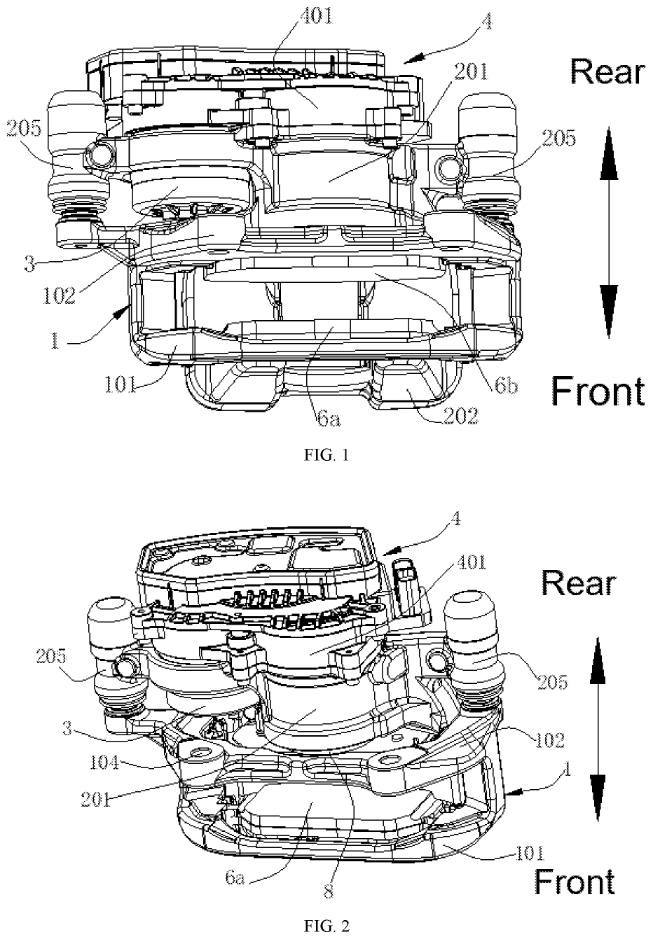

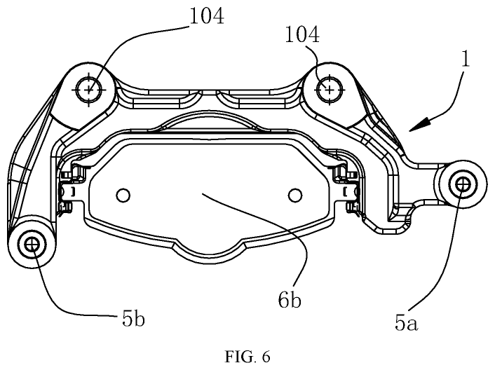

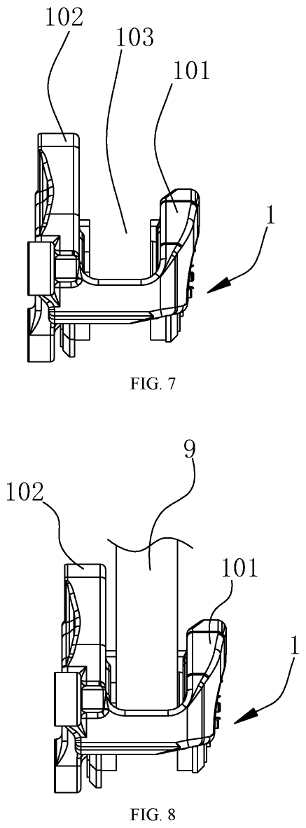

As shown in FIGS. 1-3, an electromechanical brake includes a mounting bracket 1, a caliper body 2, a brushless motor 3, and a transmission device 4. As shown in FIGS. 1-3 and FIGS. 6-8, the mounting bracket 1 includes a front jaw 101 and a rear jaw 102. An outer brake pad 6a is slidably mounted on the front jaw 101, and an inner brake pad 6b is slidably mounted on the rear jaw 102. The space between the front jaw 101 and the rear jaw 102 is used to accommodate the vehicle's brake disc 9 (see FIG. 8). Preferably, a slot 103 for accommodating the brake disc 9 is formed between the front jaw 101 and the rear jaw 102, and the rear jaw 102 is provided with one or more mounting holes 104 for securing the mounting bracket 1 to the vehicle body.

As shown in FIGS. 1-3, the caliper body 2 is slidably connected to the mounting bracket 1 via two guide rods. Specifically, the caliper body 2 is equipped with two guide sleeves 205; one end of each of the guide rods is fixed to the mounting bracket 1, while the other end of each of the guide rods is in sliding engagement with a corresponding one of the guide sleeves 205. It should be understood that the terms “one end” and “the other end” may, in some cases, be referred to as “a first end” and “a second end,” respectively, for ease of understanding and description. In an embodiment, the two guide sleeves may also be provided on the mounting bracket 1, with one end of each of the two guide rods secured to the caliper body 2 and the other end of each of the two guide rods in sliding engagement with the corresponding one of the guide sleeves on the mounting bracket 1.

As shown in FIGS. 1-3, a piston cylinder 201 is provided on the caliper body 2. Inside the piston cylinder 201 is a piston 8 that is connected to an output end of the transmission device 4 and can slide axially. The piston 8 moves forward to push the inner brake pad 6b against the brake disc 9. It should be understood that the term “move forward” refers to axial movement from the transmission device 4 toward the mounting bracket 1, as indicated in FIGS. 1 to 3, 5, and 9. The terms “front end,” “rear end,” and similar expressions used hereinafter are also defined with reference to this axial direction. A hook portion 202 is provided at the front end of the caliper body 2, located on the outer side (i.e., front side) of the outer brake pad 6a.

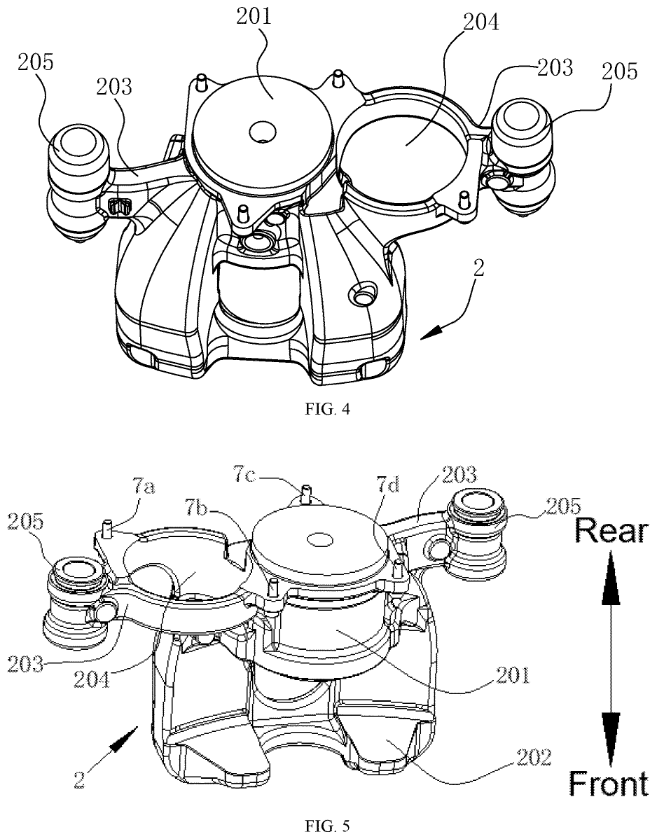

As shown in FIGS. 4 and 5, the rear end of the caliper body 2 is provided with two caliper lugs 203, which are integrally formed with the piston cylinder 201 and extend radially outward from two sides of the outer wall of the piston cylinder 201. Each of the guide sleeves 205 is mounted at the end of one of the caliper lugs 203 and is used to slidably engage one end of a corresponding guide rod. The other end of one guide rod is secured to the rear jaw 102 of the mounting bracket 1, while the other end of the other guide rod is secured to the mounting bracket 1. Preferably, the other end of the other guide rod is also secured to the rear jaw 102 of the mounting bracket 1. Alternatively, one end of one of the guide rods is fixed to the rear jaw 102, and the other end of the one of the guide rods is in sliding engagement with a guide sleeve 205 mounted on one of the caliper lugs 203; one end of the other one of the guide rods is fixed to the other one of the caliper lugs 203, and the other end of the other one of the guide rods is in sliding engagement with a guide sleeve mounted on the rear jaw 102.

By connecting each of the guide rods between one of the caliper lugs 203 and the rear jaw 102 of the mounting bracket, interference between the two guide rods and the brake disc 9 mounted between the front jaw 101 and the rear jaw 102 can be avoided.

The transmission device 4 includes a housing 401, with the brushless motor 3 mounted on the housing 401. The housing 401 is fixedly connected to the rear end of the caliper body 2 via at least three screws (see FIGS. 5, 10, and 11).

In an embodiment, as shown in FIGS. 5, 10, and 11, at least two screws are arranged on two sides of the brushless motor 3, and at least two screws are arranged on two sides of the piston cylinder 201. This ensures that the housing 401 is tightly connected to the rear end of the caliper body 2, guarantees the flatness of the connection between the housing 401 and the rear end of the caliper body 2, and enhances the caliper body's support for the brushless motor mounting portion of the housing 401, thereby effectively reducing vibration of the brushless motor mounting portion of the housing 401, which in turn effectively reduces vibration in the housing 401, thereby minimizing the risk of damage to the brushless motor 3 or electronic control unit mounted on the housing 401 and improving the reliability of the electromechanical brake to ensure driving safety.

Preferably, as shown in FIGS. 5, 9, and 10, the housing 401 is fixedly connected to the rear end of the caliper body 2 via four screws, two of which are located on two sides of the brushless motor 3 and are referred to as the first screw 7a and the second screw 7b, respectively. The second screw 7b is located on one side of the piston cylinder 201, while the remaining two screws are located on the opposite side of the piston cylinder 201 and are referred to as the third screw 7c and the fourth screw 7d, respectively.

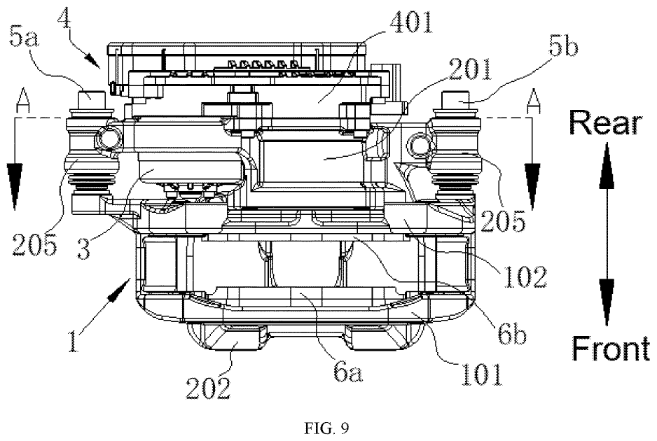

Preferably, as shown in FIGS. 9 and 11, the housing 401 is fixedly connected to the rear end of the caliper body 2 via three screws, two of which are positioned on two sides of the brushless motor 3 and are referred to as the first screw 7a and the second screw 7b, respectively. The second screw 7b is located on one side of the piston cylinder 201, while the other screw is located on the opposite side of the piston cylinder 201 and is referred to as the third screw 7c.

In an embodiment, the transmission device 4 is a gear reduction mechanism; the output end of the brushless motor 3 is connected to the input end of the transmission device 4; the output end of the transmission device 4 is an output shaft, which extends into the piston cylinder 201 and is connected to the piston 8 via a motion-conversion mechanism; the motion-conversion mechanism converts the rotation of the output shaft into linear motion of the piston 8. Preferably, the motion-conversion mechanism is a lead screw-nut mechanism.

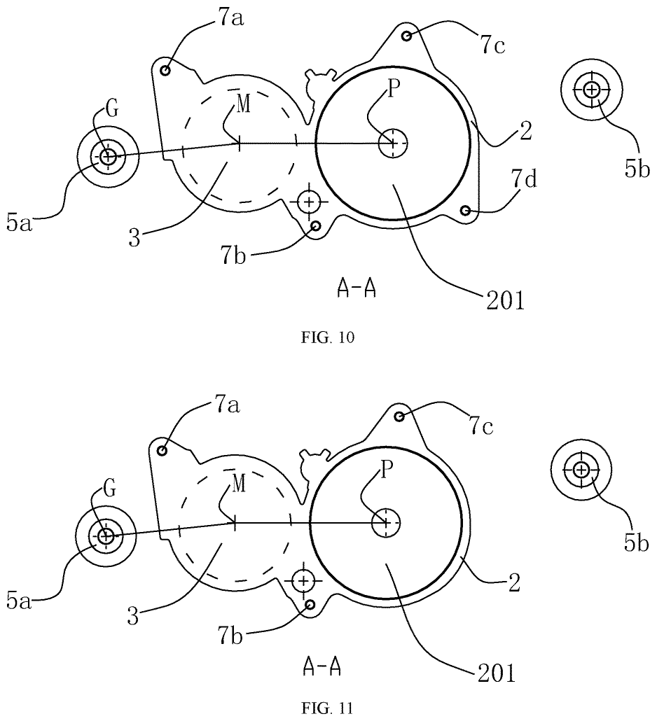

As shown in FIGS. 9 and 10, in a preferred embodiment of the present disclosure, the brushless motor 3 and the piston cylinder 201 are located between the two guide rods, and the axis of the brushless motor 3, the axis of the piston cylinder 201, and the axis of each of the two guide rods are all parallel to each other. Furthermore, the axis of the first screw 7a, the axis of the second screw 7b, the axis of the third screw 7c, and the axis of the fourth screw 7d are also parallel to the axis of the piston cylinder 201, respectively.

As shown in FIG. 10 or FIG. 11, the guide rod near the brushless motor 3 is referred to as the first guide rod 5a, and the guide rod near the piston cylinder 201 is referred to as the second guide rod 5b. In a plane perpendicular to the axis of the piston cylinder 201, the axis of the brushless motor 3, and the axis of the first guide rod 5a, the projections of the axis of the piston cylinder 201, the axis of the brushless motor 3, and the axis of the first guide rod 5a onto the plane are denoted as points P, M, and G, respectively, and the angle ∠PMG is greater than or equal to 70° and less than or equal to 180°. Since the caliper body 2 is slidably connected to the mounting bracket 1 via two guide rods, positioning the first guide rod 5a near the brushless motor 3 and setting ∠PMG to a value greater than or equal to 70° enhances the support provided by the first guide rod 5a for the portion of the caliper body 2 corresponding to the brushless motor 3, thereby improving the cantilever condition of that portion of the caliper body 2. Preferably, when ∠PMG=180°, the supporting effect of the first guide rod 5a for the portion of the caliper body 2 corresponding to the brushless motor 3 is maximized.

In an embodiment, as shown in FIGS. 1, 2, and 9, the front surface of the housing 401 is connected to the rear end of the caliper body 2, and the brushless motor 3 is mounted on the front surface of the housing 401. This avoids layout difficulties caused by insufficient space when installing the brushless motor 3 on the rear side of the housing 401, while also effectively reducing the overall structural dimensions of this electromechanical brake.

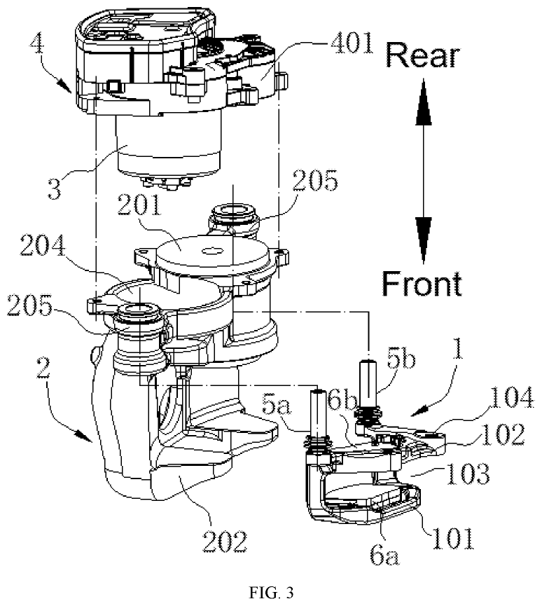

In an embodiment, as shown in FIGS. 3-5, a clearance space 204 is provided on the caliper body 2 to prevent interference with the brushless motor 3. Preferably, the clearance space 204 is a through-hole and is provided on one of the caliper lugs 203. This allows the housing of brushless motor 3 to be received in the through-hole in clearance space 204.

The operating principle of the electromechanical brake in the present disclosure is as follows: When the vehicle needs to brake, the brushless motor 3 rotates; the torque output by the brushless motor 3 is reduced in speed and increased in torque via the transmission device 4; then, through a motion-conversion mechanism, the rotational motion of the output shaft of the transmission device 4 is converted into linear motion, driving the piston 8 to slide axially relative to the piston cylinder 201. As the piston 8 moves forward within the piston cylinder 201, it pushes the inner brake pad 6b to slide forward relative to rear jaw 102 of the mounting bracket 1, causing the inner brake pad 6b to contact and clamp against the vehicle's brake disc 9. The brake disc 9, under the compressive force of the inner brake pad 6b, exerts a counterforce on the inner brake pad 6b. The inner brake pad 6b, in turn, exerts a counterforce on the piston 8 and the caliper body 2, causing the caliper body 2 to slide backward along the two guide rods relative to the mounting bracket 1. As the caliper body 2 slides backward relative to the mounting bracket 1, its hook portion 202 pushes the outer brake pad 6a backward relative to the mounting bracket's front jaw 101, causing the outer brake pad 6a to also contact and clamp the brake disc 9. In this way, the inner brake pad 6b and the outer brake pad 6a simultaneously apply pressure and friction to both sides of the brake disc 9, thereby braking the wheel.

The above-mentioned embodiments are illustrative. It should be noted that those skilled in the art can make various improvements and transformations without departing from the technical principles of the present disclosure. These improvements and transformations shall be still covered by the scope of the present disclosure.

1. An electromechanical brake, comprising a mounting bracket (1), a caliper body (2), a brushless motor (3), and a transmission device (4), wherein the caliper body (2) is slidably connected to the mounting bracket (1) via two guide rods, an inner brake pad (6b) and an outer brake pad (6a) are slidably mounted on the mounting bracket (1), and a brake disc (9) is positioned between the inner brake pad (6b) and the outer brake pad (6a); wherein the caliper body (2) is provided with a piston cylinder (201), and the piston cylinder (201) houses a piston (8); wherein the piston (8) is connected to an output end of the transmission device (4) and is capable of axial sliding, and forward movement of the piston (8) pushes the inner brake pad (6b) against the brake disc (9); wherein a front end of the caliper body (2) is provided with a hook portion (202) located on an outer side of the outer brake pad (6a); wherein the transmission device (4) comprises a housing (401), the brushless motor (3) is mounted on the housing (401), and the housing (401) is fixedly connected to a rear end of the caliper body (2) via a fastener.

2. The electromechanical brake according to claim 1, wherein the fastener comprises at least three screws, at least two of the screws are disposed on two sides of the brushless motor (3), and at least two of the screws are disposed on two sides of the piston cylinder (201).

3. The electromechanical brake according to claim 1, wherein the transmission device (4) is a gear reduction mechanism, an output end of the brushless motor (3) is connected to an input end of the transmission device (4), the output end of the transmission device (4) is an output shaft, and the output shaft extends into the piston cylinder (201) and is connected to the piston (8) via a motion-conversion mechanism.

4. The electromechanical brake according to claim 1, wherein the brushless motor (3) and the piston cylinder (201) are located between the two guide rods, and an axis of the brushless motor (3), an axis of the piston cylinder (201), and an axis of each of the two guide rods are all parallel to each other.

5. The electromechanical brake according to claim 4, wherein the two guide rods comprise a first guide rod (5a) and a second guide rod (5b), the first guide rod (5a) is positioned adjacent to the brushless motor (3), and the second guide rod (5b) is positioned adjacent to the piston cylinder (201); wherein in a plane perpendicular to each of the axis of the piston cylinder (201), the axis of the brushless motor (3), and an axis of the first guide rod (5a), projections of the axis of the piston cylinder (201), the axis of the brushless motor (3), and the axis of the first guide rod (5a) onto the plane are denoted as points P, M, and G, respectively, and an angle ∠PMG is greater than or equal to 70° and less than or equal to 180°.

6. The electromechanical brake according to claim 1, wherein the mounting bracket (1) comprises a front jaw (101) and a rear jaw (102), wherein the outer brake pad (6a) is slidably mounted on the front jaw (101), and the inner brake pad (6b) is slidably mounted on the rear jaw (102).

7. The electromechanical brake according to claim 6, wherein the rear end of the caliper body (2) is provided with two caliper lugs (203), and the two caliper lugs (203) are integrally formed with the piston cylinder (201) and extend radially outward from two sides of an outer wall of the piston cylinder (201); wherein a first guide rod (5a) is connected between one of the two caliper lugs (203) and the rear jaw (102), and a second guide rod (5b) is connected between remaining one of the two caliper lugs (203) and the rear jaw (102).

8. The electromechanical brake according to claim 7, wherein a first end of each of the first guide rod (5a) and the second guide rod (5b) is fixed to the rear jaw (102), and a second end of each of the first guide rod (5a) and the second guide rod (5b) is in sliding engagement with a corresponding one of guide sleeves (205) mounted on the caliper lugs (203).

9. The electromechanical brake according to claim 7, wherein a first end of one of the first guide rod (5a) and the second guide rod (5b) is fixed to the rear jaw (102), and a second end of the one of the first guide rod (5a) and the second guide rod (5b) is in sliding engagement with a guide sleeve (205) mounted on one of the caliper lugs (203); wherein a first end of remaining one of the first guide rod (5a) and the second guide rod (5b) is fixed to remaining one of the caliper lugs (203), and a second end of the remaining one of the first guide rod (5a) and the second guide rod (5b) is in sliding engagement with a guide sleeve (205) mounted on the rear jaw (102).

10. The electromechanical brake according to claim 6, wherein a slot (103) for accommodating the brake disc (9) is formed between the front jaw (101) and the rear jaw (102), and the rear jaw (102) is provided with one or more mounting holes (104) configured for vehicle-body mounting.

11. The electromechanical brake according to claim 7, wherein a front surface of the housing (401) is connected to the rear end of the caliper body (2), and the brushless motor (3) is mounted on the front surface of the housing (401).

12. The electromechanical brake according to claim 11, wherein the caliper body (2) is provided with a clearance space (204) to prevent interference with the brushless motor (3).

13. The electromechanical brake according to claim 12, wherein the clearance space (204) is a through-hole and is provided in one of the caliper lugs (203).
